(19) United States
(12) Patent Application Publication
(10) Pub. No.: US 2024/0093090 A1
(43) Pub. Date: Mar. 21, 2024

(54) CORROSION INHIBITOR COMPOSITIONS AND METHODS OF USING THE SAME

(71) Applicant: ChampionX USA Inc., Sugar Land, TX (US)

(72) Inventor: Jeremy MOLONEY, Katy, TX (US)

(73) Assignee: ChampionX USA Inc., Sugar Land, TX (US)

(21) Appl. No.: 18/452,245

(22) Filed: Aug. 18, 2023

Related U.S. Application Data
(60) Provisional application No. 63/400,185, filed on Aug. 23, 2022.

(51) Int. Cl. C09K 15/30; C09K 15/16; C23F 11/14

(52) U.S. Cl. CPC C09K 15/30; C09K 15/16; C23F 11/149

(57) ABSTRACT

The disclosure provides a composition including a corrosion inhibitor compound and an anti-emulsifier compound. The composition has a weight ratio of the anti-emulsifier to the corrosion inhibitor of about 20:1 to about 0.2:1. The composition may be used in a method of inhibiting corrosion of a metal surface. The method includes adding the composition to an aqueous system that includes the metal surface.

### TECHNICAL FIELD

The present disclosure generally relates to corrosion inhibitor compositions and methods of using the compositions. More particularly, the present disclosure relates to corrosion inhibitor compositions comprising an anti-emulsifier compound and methods of using the compositions in, for example, oil and gas production wells and/or pipelines.

### BACKGROUND

Corrosion inhibitors are often added into upstream oil and gas production fluids to protect carbon steel pipelines and infrastructure from corrosion. Being surfactant in nature, corrosion inhibitors have the potential to induce emulsions in multi-phase pipelines transporting both liquid hydrocarbon and water. Although anti-emulsifier chemistries can be added to a corrosion inhibitor to help mitigate emulsions, in many systems, the corrosion inhibitor dose rates can be low enough where they do not need to be added while in other situations, only a small amount of anti-emulsifier chemistry (relative to the corrosion inhibitor active) may be added, oftentimes at amounts of 50:1 to 10:1 of corrosion inhibitor active to anti-emulsifier chemistry. Adding excess anti-emulsifier can result in overtreatment scenarios resulting in problems, which include exacerbating emulsion issues.

In some systems, such as sour gas applications, higher amounts of corrosion inhibitor may be required to control the corrosion mechanism resulting in large concentrations of corrosion inhibitor actives in the water phase. This can be compounded in cases of very low water cuts (<5% water) where the corrosion inhibitor actives may further accumulate in the water base and at the water/oil interface resulting in severe emulsions. Due to infrastructure limitations, some systems may only be able to inject one oilfield product at an upstream location so oftentimes corrosion inhibitor injection would be selected over anti-emulsifier injection for asset integrity purposes. Anti-emulsifier application at a location further downstream is often a strategy to attend to corrosion inhibitor-induced emulsions but can be much less efficient, effective and/or economic while in some cases, emulsions may be so stabilized that separation may need non-chemical approaches in conjunction with demulsification.

### BRIEF SUMMARY

In some embodiments, the present disclosure provides a composition. The composition comprises a corrosion inhibitor compound and an anti-emulsifier compound. The composition comprises a weight ratio of the anti-emulsifier to the corrosion inhibitor of about 20:1 to about 0.2:1.

The present disclosure also provides a method of inhibiting corrosion of a metal surface. The method comprises adding a composition to an aqueous system comprising the metal surface. The composition comprises a corrosion inhibitor and an anti-emulsifier with a weight ratio of the anti-emulsifier to the corrosion inhibitor of about 20:1 to about 0.2:1.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

The present disclosure provides compositions and methods that can be used in industrial aqueous systems. In some embodiments, the compositions and methods may be used to inhibit corrosion of a metallic surface present in an oil and gas production well and/or pipeline.

The corrosion inhibitor compositions disclosed herein may comprise a variety of treatment chemicals and/or compounds, such as corrosion inhibitor compounds and anti-emulsifier compounds. In certain embodiments, a composition of the present disclosure consists of or consists essentially of a corrosion inhibitor compound and an anti-emulsifier compound.

Examples of corrosion inhibitor compounds include, but are not limited to, an organic sulfur compound, an imidazoline, a carboxylic acid, a fatty acid amine condensate, a substituted fatty acid ester, a substituted aromatic amine, a phosphoric acid ester, a quaternary ammonium compound, or a compound comprising multiple positive charges.

In some embodiments, a composition disclosed herein comprises, consists of, or consists essentially of, an imidazoline compound, a quaternary amine, an anti-emulsifier compound, and optionally a solvent. In some embodiments, a composition disclosed herein comprises, consists of, or consists essentially of, an imidazoline compound, a quaternary amine, a phosphonium compound, an anti-emulsifier compound, and optionally a solvent.

The imidazoline compound may have formula (I), (II), or (III):

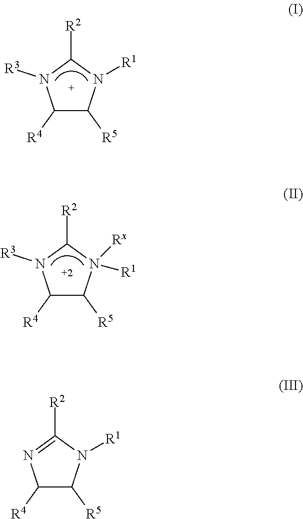

wherein R¹, R⁴, and R⁵ are each independently selected from hydrogen, alkyl, alkenyl, alkynyl, cycloalkyl, cycloalkenyl, aryl, heteroaryl, and heterocycle, said alkyl, alkenyl, alkynyl, cycloalkyl, cycloalkenyl, aryl, heteroaryl, and heterocycle each independently, at each occurrence, unsubstituted or substituted with 1 to 3 substituents independently selected from halogen, —COR⁶, —CO₂R⁷, —SO₃R⁸, —PO₃H₂, —CON(R⁹)(R¹⁰), —OR¹¹, and —N(R¹²)(R¹³);
R² is a radical derived from a fatty acid;
R³ and Rx are each independently selected from a radical derived from an unsaturated acid;
R⁶, R⁷, R⁸, R⁹, R¹⁰, and R¹¹ are each independently, at each occurrence, selected from hydrogen, alkyl, and alkenyl;
R¹² and R¹³ are each independently, at each occurrence, selected from hydrogen, alkyl, —COR¹⁴, —CO₂R¹⁵, -alkyl-COR¹⁶, and -alkyl-CO₂R¹⁷; and
R¹⁴, R¹⁵, R¹⁶, and R¹⁷ are each independently, at each occurrence, selected from hydrogen, alkyl, and alkenyl.

In the foregoing imidazolines, R groups of carboxylic acid moieties can be absent where the R═H and the carboxylic acid moiety is deprotonated. For example, R¹⁵ and/or R¹⁷ can be absent where the R¹² and/or R¹³ is a deprotonated carboxylic acid moiety (e.g., where R¹² is —CH₂CH₂CO₂⁻). For an imidazoline compound, R¹ can be unsubstituted alkyl. For example, R¹ can be unsubstituted C₁-C₁₀-alkyl (e.g., methyl, ethyl, propyl (e.g., n-propyl, isopropyl), butyl (e.g., n-butyl, isobutyl, tert-butyl, sec-butyl), pentyl (e.g., n-pentyl, isopentyl, tert-pentyl, neopentyl, sec-pentyl, 3-pentyl), hexyl, heptyl, octyl, nonyl, or decyl). Further, R¹ can be unsubstituted C₂-C₁₀-alkyl. For the imidazoline compounds, R¹ can be unsubstituted C₂-C₈-alkyl. Further, R¹ can be unsubstituted C₂-C₆-alkyl. In some embodiments, R¹ is propyl, butyl, or hexyl.

In some embodiments, R¹ is a substituted alkyl. For example, R¹ may be a substituted C₁-C₁₀-alkyl, substituted C₂-C₁₀-alkyl, substituted C₂-C₈-alkyl, or substituted C₂-C₆-alkyl. Further, R¹ may be a C₁-C₁₀-alkyl, C₂-C₁₀-alkyl, C₂-C₈-alkyl, or C₂-C₆-alkyl, substituted with one substituent selected from —COR⁶, —CO₂R⁷, —SO₃R⁸, —PO₃H₂, —CON(R⁹)(R¹⁰), —OR¹¹, and —N(R¹²)(R¹³), wherein R⁶, R⁷, R⁸, R⁹, R¹⁰, R¹¹, R¹², and R¹³ are as defined above. More specifically, R¹ may be a C₂-C₆-alkyl, substituted with one substituent selected from —N(R¹²)(R¹³), wherein R¹² and R¹³ are each independently selected from hydrogen, alkyl, —COR¹⁴, —CO₂R¹⁵, -alkyl-COR¹⁶, and -alkyl-CO₂R¹⁷, wherein R¹⁴, R¹⁵, R¹⁶, and R¹⁷ are as defined above. Further, R¹ may be a C₂-C₆-alkyl, substituted with one substituent selected from —N(R¹²)(R¹³), wherein R¹² and R¹³ are each independently selected from hydrogen, C₂-C₆-alkyl, —COR¹⁴, —CO₂R¹⁵, —C₂-C₆-alkyl-COR¹⁶, and —C₂-C₆-alkyl-CO₂R¹⁷, wherein R¹⁴, R¹⁵, R¹⁶, and R¹⁷ are selected from hydrogen and C₁-C₃₄-alkyl. For these imidazolines, R¹ may be a linear C₂-C₆-alkyl, substituted with one substituent that is a terminal —N(R¹²)(R¹³), wherein R¹² and R¹³ are each independently selected from hydrogen, —COR¹⁴, —CO₂R¹⁵, —C₂-C₆-alkyl-COR¹⁶, and —C₂-C₆-alkyl-CO₂R¹⁷, wherein R¹⁴, R¹⁵, R¹⁶, and R¹⁷ are selected from hydrogen and C₁-C₃₄-alkyl. For example, R¹ may be a linear C₂-alkyl, substituted with one substituent that is a terminal —N(R¹²)(R¹³), wherein R¹² is hydrogen and R¹³ is —COR¹⁴, wherein R¹⁴ is —C₁₇H₃₅, —C₁₇H₃₃, or —C₁₇H₃₁. Further, R¹ may be a linear C₂-alkyl, substituted with one substituent that is a terminal —N(R¹²)(R¹³), wherein R¹² and R¹³ are each a —C₂-alkyl-CO₂R¹⁷, wherein R¹⁷ is hydrogen.

For the imidazolines of formulae (I), (II), and (III), R² may be a C₄-C₃₄-alkyl or C₄-C₃₄-alkenyl. For example, R² may be a —(CH₂)₃CH₃; —(CH₂)₄CH₃; —(CH₂)₅CH₃; —(CH₂)₆CH₃; —(CH₂)₇CH₃; —(CH₂)₈CH₃; —(CH₂)₉CH₃; —(CH₂)₁₀CH₃; —(CH₂)₁₁CH₃; —(CH₂)₁₂CH₃; —(CH₂)₁₃CH₃; —(CH₂)₁₄CH₃; —(CH₂)₁₅CH₃; —(CH₂)₁₆CH₃; —(CH₂)₁₇CH₃; —(CH₂)₁₈CH₃; —(CH₂)₁₉CH₃; —(CH₂)₂₀CH₃; —(CH₂)₂₁CH₃; —(CH₂)₂₂CH₃; —(CH₂)₂₃CH₃; —(CH₂)₂₄CH₃; —(CH₂)₂₅CH₃; —(CH₂)₂₆CH₃; —(CH₂)₂₇CH₃; —(CH₂)₂₈CH₃; —(CH₂)₂₉CH₃; —(CH₂)₃₀CH₃; —(CH₂)₃₁CH₃; —(CH₂)₃₂CH₃; —(CH₂)₃₃CH₃; —(CH₂)₃₄CH₃; —(CH₂)₂CH═CHCH₂CH═CHCH₂CH═CHCH₂CH═CHCH₂CH═CH(CH₂)₄CH₃; —(CH₂)₂CH═CHCH₂CH═CHCH₂CH═CHCH₂CH═CHCH₂CH═CHCH₂CH═CHCH₂CH₃; —(CH₂)₃CH═CHCH₂CH═CHCH₂CH═CH(CH₂)₇CH₃; —(CH₂)₃CH═CHCH₂CH₂CH═CHCH₂CH═CH(CH₂)₄CH₃; —(CH₂)₃CH═CH(CH₂)₄CH═CHCH₂CH═CH(CH₂)₄CH₃; —(CH₂)₃CH═CHCH₂CH═CHCH₂CH═CHCH₂CH═CH(CH₂)₄CH₃; —(CH₂)₃CH═CHCH₂CH═CHCH₂CH═CHCH₂CH═CHCH₂CH═CHCH₂CH₃; —(CH₂)₃CH═CHCH═CHCH═CHCH═CHCH═CH(CH₂)₄CH₃; —(CH₂)₄CH═CH(CH₂)₈CH₃; —(CH₂)₄CH═CHCH₂CH═CHCH₂CH═CH(CH₂)₄CH₃; —(CH₂)₄CH═CHCH₂CH═CHCH₂CH═CHCH₂CH═CHCH₂CH₃; —(CH₂)₄CH═CHCH₂CH═CHCH₂CH═CHCH₂CH═CHCH₂CH═CHCH₂CH₃; —(CH₂)₄CH═CHCH₂CH═CHCH₂CH═CHCH₂CH═CHCH₂CH═CH(CH₂)₄CH₃; —(CH₂)₄CH═CHCH₂CH═CHCH₂CH═CHCH₂CH═CHCH₂CH═CHCH₂CH═CHCH₂CH₃; —(CH₂)₅CH═CHCH₂CH═CHCH₂CH═CHCH₂CH₃; —(CH₂)₅CH═CHCH₂CH═CHCH₂CH═CHCH₂CH═CH(CH₂)₄CH₃; —(CH₂)₅CH═CHCH₂CH═CHCH₂CH═CHCH₂CH═CHCH₂CH═CHCH₂CH₃; —(CH₂)₆CH═CHCH═CHCH═CH(CH₂)₄CH₃; —(CH₂)₆CH═CHCH₂CH═CHCH₂CH═CHCH₂CH═CH(CH₂)₄CH₃; —(CH₂)₇CH═CH(CH₂)₃CH₃; —(CH₂)₇CH═CH(CH₂)₅CH₃; —(CH₂)₇CH═CH(CH₂)₇CH₃; —(CH₂)₇CH═CHCH═CHCH═CH(CH₂)₃CH₃; —(CH₂)₇CH═CHCH═CH(CH₂)₅CH₃; —(CH₂)₇CH═CHCH₂CH═CH(CH₂)₄CH₃; —(CH₂)₇CH═CHCH₂CH═CH(CH₂)₄CH₃; —(CH₂)₇CH═CHCH═CHCH₂CH₂CH═CHCH₂CH₃; —(CH₂)₇CH═CHCH═CHCH═CHCH═CHCH₂CH₃; —(CH₂)₇CH═CHCH₂CH═CHCH₂CH═CHCH₂CH═CH(CH₂)₄CH₃; —(CH₂)₇CH═CHCH₂CH═CHCH₂CH═CHCH₂CH₃; —(CH₂)₇CH═CHCH₂CH═CHCH₂CH═CHCH₂CH═CHCH₂CH═CHCH₂CH₃; —(CH₂)₉CH═CH(CH₂)₅CH₃; —(CH₂)₉CH═CHCH₂CH═CH(CH₂)₄CH₃; —(CH₂)₉CH═CHCH₂CH═CHCH₂CH═CHCH₂CH₃; —(CH₂)₉CH═CH(CH₂)₇CH₃; —(CH₂)₁₁CH═CH(CH₂)₅CH₃; —(CH₂)₁₁CH═CH(CH₂)₇CH₃; —(CH₂)₁₁CH═CHCH₂CH═CH(CH₂)₄CH₃; or —(CH₂)₁₃CH═CH(CH₂)₇CH₃.

In some embodiments, R² may be a radical derived from a saturated or unsaturated fatty acid. Suitable saturated fatty acids include, but are not limited to, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, henatriacontylic acid, lacceroic acid, psyllic acid, geddic acid, ceroplastic acid, and hexatriacontylic acid. Suitable unsaturated fatty acids include, but are not limited to, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, hexadecatrienoic acid, stearidonic acid, eicosatrienoic acid, eicosatetraenoic acid, heneicosapentaenoic acid, clupanodonic acid, osbond acid, (9Z,12Z,15Z,18Z,21Z)-tetracosa-9,12, 15, 18,21-pentaenoic acid, nisinic acid, γ-linolenic acid, eicosadienoic acid, dihomo-γ-linolenic acid, docosadienoic acid, adrenic acid, tetracosatetraenoic acid, (6Z,9Z,12Z,15Z,18Z)-tetracosa-6,9, 12, 15,18-pentaenoic acid, (Z)-Eicos-11-enoic acid, mead acid, erucic acid, nervonic acid, rumenic acid, α-calendic acid, β-calendic acid, jacaric acid, α-eleostearic acid, β-eleostearic acid, catalpic acid, punicic acid, rumelenic acid, α-parinaric acid, β-parinaric acid, bosseopentaenoic acid, pinolenic acid, and podocarpic acid. In some embodiments, R² is derived from coconut oil, beef tallow, or tall oil fatty acids (TOFA).

In some embodiments, R³ may be —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and alkyl, and wherein R^{e} is hydrogen (—H) or alkyl. For example, R³ may be —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and C₁-C₆-alkyl, and wherein R^{e} is hydrogen (—H) or C₁-C₆-alkyl. Further, R³ may be —CH₂CH₂CO₂R^{e}, wherein R^{e} is hydrogen (—H) or C₁-C₆-alkyl. Additionally, R^{e} can be absent where the R³ is a deprotonated carboxylic acid moiety (e.g., where R³ is —CH₂CH₂CO₂⁻).

In accordance with certain embodiments of the present disclosure, R³ can be derived from an acrylic acid. Suitable acrylic acids include, but are not limited to, acrylic acid, methacrylic acid, 2-ethylacrylic acid, 2-propylacrylic acid, and 2-(trifluoromethyl)acrylic acid. For example, R³ can be derived from acrylic acid (H₂C═CHCO₂H).

Imidazolines of formulae (I), (II), or (III) may have R^{x} equal to —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and alkyl, and wherein R^{e} is hydrogen (—H) or alkyl. Further, R^{x} can be —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and C₁-C₆-alkyl, and wherein R^{e} is hydrogen (—H) or C₁-C₆-alkyl. Additionally, R^{x} may be —CH₂CH₂CO₂R^{e}, wherein R^{e} is hydrogen (—H) or C₁-C₆-alkyl. Further, R^{e} can be absent where the R^{x} is a deprotonated carboxylic acid moiety (e.g., where R^{x} is —CH₂CH₂CO₂⁻).

For the imidazolines described herein, R^{x} can be derived from an acrylic acid. Suitable acrylic acids include, but are not limited to, acrylic acid, methacrylic acid, 2-ethylacrylic acid, 2-propylacrylic acid, and 2-(trifluoromethyl)acrylic acid. For example, R^{x} can be derived from acrylic acid (H₂C═CHCO₂H).

Imidazolines of formulae (I), (II), or (III) can have R⁴ and R⁵ each independently be an unsubstituted C₁-C₁₀-alkyl (e.g., methyl, ethyl, propyl (e.g., n-propyl, isopropyl), butyl (e.g., n-butyl, isobutyl, tert-butyl, sec-butyl), pentyl (e.g., n-pentyl, isopentyl, tert-pentyl, neopentyl, sec-pentyl, 3-pentyl), hexyl, heptyl, octyl, nonyl, or decyl) or hydrogen. Further, R⁴ and R⁵ can each independently be an unsubstituted C₁-C₆ alkyl group or hydrogen. In some embodiments, R⁴ and R⁵ are each hydrogen (—H).

Imidazolines of formulae (I), (II), or (III) can have R⁶, R⁷, R⁸, R⁹, R¹⁰, and R¹¹ each independently be, at each occurrence, selected from hydrogen, unsubstituted alkyl, and unsubstituted alkenyl. For example, R⁶, R⁷, R⁸, R⁹, R¹⁰, and R¹¹ can each independently be, at each occurrence, selected from hydrogen, unsubstituted C₁-C₃₄-alkyl, and unsubstituted C₂-C₃₄-alkenyl. Further, R⁶, R⁷, R⁸, R⁹, R¹⁰, and R¹¹ can each independently be, at each occurrence, selected from hydrogen, unsubstituted C₁-C₁₀-alkyl, and unsubstituted C₂-C₁₀-alkenyl. Further, R⁶, R⁷, R⁸, R⁹, R¹⁰, and R¹¹ can each independently be, at each occurrence, selected from hydrogen, and a radical derived from a fatty acid.

R¹² and R¹³ can each independently be, at each occurrence, selected from hydrogen, C₁-C₁₀-alkyl, —COR¹⁴, —CO₂R¹⁵, —C₁-C₁₀-alkyl-COR¹⁶, and —C₁-C₁₀-alkyl-CO₂R¹⁷. Further, R¹² and R¹³ can each independently be, at each occurrence, selected from hydrogen, unsubstituted —COR¹⁴, —CO₂R¹⁵, —C₁-C₁₀-alkyl-COR¹⁶, and —C₁-C₁₀-alkyl-CO₂R¹⁷.

R¹⁴, R¹⁵, R¹⁶, and R¹⁷ can each independently be, at each occurrence, selected from hydrogen, unsubstituted alkyl, and unsubstituted alkenyl. Further, R¹⁴, R¹⁵, R¹⁶, and R¹⁷ can each independently be, at each occurrence, selected from hydrogen, unsubstituted C₁-C₃₄-alkyl, and unsubstituted C₂-C₃₄-alkenyl. Additionally, R¹⁴, R¹⁵, R¹⁶, and R¹⁷ can each independently be, at each occurrence, selected from hydrogen, unsubstituted C₁-C₁₀-alkyl, and unsubstituted C₂-C₁₀-alkenyl. Further, R¹⁵ and/or R¹⁷ can be absent where the carboxylic acid moiety is deprotonated.

Imidazoline compounds of the present disclosure can have R¹⁴, R¹⁵, R¹⁶, and R¹⁷ each independently be, at each occurrence, selected from hydrogen, and a radical derived from a fatty acid. Further, R¹⁴, R¹⁵R¹⁶ and R¹⁷ can each independently be, at each occurrence, selected from hydrogen, C₄-C₃₄-alkyl, and C₄-C₃₄-alkenyl. Additionally, R¹⁴, R¹⁵, R¹⁶ and R¹⁷ can each independently be, at each occurrence, selected from hydrogen; —(CH₂)₃CH₃; —(CH₂)₄CH₃; —(CH₂)₅CH₃; —(CH₂)₆CH₃; —(CH₂)₇CH₃; —(CH₂)₈CH₃; —(CH₂)₉CH₃; —(CH₂)₁₀CH₃; —(CH₂)₁₁CH₃; —(CH₂)₁₂CH₃; —(CH₂)₁₃CH₃; —(CH₂)₁₄CH₃; —(CH₂)₁₅CH₃; —(CH₂)₁₆CH₃; —(CH₂)₁₇CH₃; —(CH₂)₁₈CH₃; —(CH₂)₁₉CH₃; —(CH₂)₂₀CH₃; —(CH₂)₂₁CH₃; —(CH₂)₂₂CH₃; —(CH₂)₂₃CH₃; —(CH₂)₂₄CH₃; —(CH₂)₂₅CH₃; —(CH₂)₂₆CH₃; —(CH₂)₂₇CH₃; —(CH₂)₂₈CH₃; —(CH₂)₂₉CH₃; —(CH₂)₃₀CH₃; —(CH₂)₃₁CH₃; —(CH₂)₃₂CH₃; —(CH₂)₃₃CH₃; —(CH₂)₃₄CH₃; —(CH₂)₂CH═CHCH₂CH═CHCH₂CH═CHCH₂CH═CHCH₂CH═CH(CH₂)₄CH₃; —(CH₂)₂CH═CHCH₂CH═CHCH₂CH═CHCH₂CH═CHCH₂CH═CHCH₂CH═CHCH₂CH₃; —(CH₂)₃CH═CHCH₂CH═CHCH₂CH═CH(CH₂)₇CH₃; —(CH₂)₃CH═CHCH₂CH₂CH═CHCH₂CH═CH(CH₂)₄CH₃; —(CH₂)₃CH═CH(CH₂)₄CH═CHCH₂CH═CH(CH₂)₄CH₃; —(CH₂)₃CH═CHCH₂CH═CHCH₂CH═CHCH₂CH═CH(CH₂)₄CH₃; —(CH₂)₃CH═CHCH₂CH═CHCH₂CH═CHCH₂CH═CHCH₂CH═CHCH₂CH₃; —(CH₂)₃CH═CHCH═CHCH═CHCH═CHCH═CH(CH₂)₄CH₃; —(CH₂)₄CH═CH(CH₂)₅CH₃; —(CH₂)₄CH═CHCH₂CH═CHCH₂CH═CH(CH₂)₄CH₃; —(CH₂)₄CH═CHCH₂CH═CHCH₂CH═CHCH₂CH═CHCH₂CH₃; —(CH₂)₄CH═CHCH₂CH═CHCH₂CH═CHCH₂CH═CHCH₂CH═CHCH₂CH₃; —(CH₂)₄CH═CHCH₂CH═CHCH₂CH═CHCH₂CH═CHCH₂CH═CH(CH₂)₄CH₃; —(CH₂)₄CH═CHCH₂CH═CHCH₂CH═CHCH₂CH═CHCH₂CH═CHCH₂CH═CHCH₂CH₃; —(CH₂)₅CH═CHCH₂CH═CHCH₂CH═CHCH₂CH₃; —(CH₂)₅CH═CHCH₂CH═CHCH₂CH═CHCH₂CH═CH(CH₂)₄CH₃; —(CH₂)₅CH═CHCH₂CH═CHCH₂CH═CHCH₂CH═CHCH₂CH═CHCH₂CH₃; —(CH₂)₆CH═CHCH═CHCH═CH(CH₂)₄CH₃; —(CH₂)₆CH═CHCH₂CH═CHCH₂CH═CHCH₂CH═CH(CH₂)₄CH₃; —(CH₂)₇CH═CH(CH₂)₃CH₃; —(CH₂)₇CH═CH(CH₂)₅CH₃; —(CH₂)₇CH═CH(CH₂)₇CH₃; —(CH₂)₇CH═CHCH═CHCH═CH(CH₂)₃CH₃; —(CH₂)₇CH═CHCH═CH(CH₂)₅CH₃; —(CH₂)₇CH═CHCH₂CH═CH(CH₂)₄CH₃; —(CH₂)₇CH═CHCH₂CH═CH(CH₂)₄CH₃; —(CH₂)₇CH═CHCH═CHCH₂CH₂CH═CHCH₂CH₃; —(CH₂)₇CH═CHCH═CHCH═CHCH═CHCH₂CH₃; —(CH₂)₇CH═CHCH₂CH═CHCH₂CH═CHCH₂CH═CH(CH₂)₄CH₃; —(CH₂)₇CH═CHCH₂CH═CHCH₂CH═CHCH₂CH₃; —(CH₂)₇CH═CHCH₂CH═CHCH₂CH═CHCH₂CH═CHCH₂CH═CHCH₂CH₃; —(CH₂)₉CH═CH(CH₂)₅CH₃; —(CH₂)₉CH═CHCH₂CH═CH(CH₂)₄CH₃; —(CH₂)₉CH═CHCH₂CH═CHCH₂CH═CHCH₂CH₃; —(CH₂)₉CH═CH(CH₂)₇CH₃; —(CH₂)₁₁CH═CH(CH₂)₅CH₃; —(CH₂)₁₁CH═CH(CH₂)₇CH₃; —(CH₂)₁₁CH═CHCH₂CH═CH(CH₂)₄CH₃; and —(CH₂)₁₃CH═CH(CH₂)₇CH₃.

For the imidazolines of formulae (I), (II), and (III), R¹⁴, R¹⁵, R¹⁶, and R¹⁷ can each independently be, at each occurrence, selected from hydrogen, a radical derived from a saturated fatty acid, and a radical derived from an unsaturated fatty acid. Suitable saturated fatty acids include, but are not limited to, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, henatriacontylic acid, lacceroic acid, psyllic acid, geddic acid, ceroplastic acid, and hexatriacontylic acid. Suitable unsaturated fatty acids include, but are not limited to, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, hexadecatrienoic acid, stearidonic acid, eicosatrienoic acid, eicosatetraenoic acid, heneicosapentaenoic acid, clupanodonic acid, osbond acid, (9Z, 12Z, 15Z, 18Z,21Z)-tetracosa-9, 12, 15, 18,21-pentaenoic acid, nisinic acid, γ-linolenic acid, eicosadienoic acid, dihomo-γ-linolenic acid, docosadienoic acid, adrenic acid, tetracosatetraenoic acid, (6Z,9Z, 12Z, 15Z, 18Z)-tetracosa-6, 9, 12, 15, 18-pentaenoic acid, (Z)-Eicos-11-enoic acid, mead acid, erucic acid, nervonic acid, rumenic acid, α-calendic acid, β-calendic acid, jacaric acid, α-eleostearic acid, β-eleostearic acid, catalpic acid, punicic acid, rumelenic acid, α-parinaric acid, β-parinaric acid, bosseopentaenoic acid, pinolenic acid, and podocarpic acid.

Further, R¹⁴, R¹⁵, R¹⁶, and R¹⁷ are each independently, at each occurrence, hydrogen or a radical derived from coconut oil, beef tallow, or tall oil fatty acids (TOFA).

In some embodiments, the imidazoline is a compound of formula (I), wherein R¹ is unsubstituted C₂-C₆-alkyl; R² is —C₁₇H₃₅, —C₁₇H₃₃, or —C₁₇H₃₁; R³ is —CH₂CH₂CO₂R^{e}, wherein Re is hydrogen (—H), C₁-C₆-alkyl, or R^{e} is absent (e.g., R³ is —CH₂CH₂CO₂⁻); R⁴ is hydrogen; and R⁵ is hydrogen.

In some embodiments, the imidazoline is a compound of formula (I), wherein R¹ is linear C₂-alkyl, substituted with one substituent that is a terminal —N(R¹²)(R¹³), wherein R¹² is hydrogen and R¹³ is —COR¹⁴ wherein R¹⁴ is —C₁₇H₃₅, —C₁₇H₃₃, or —C₁₇H₃₁; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂⁻); R⁴ is hydrogen; and R⁵ is hydrogen.

In certain embodiments, the imidazoline is a compound of formula (I), wherein R¹ is linear C₂-alkyl, substituted with one substituent that is a terminal —N(R¹²)(R¹³), wherein R¹² and R¹³ are each a —C₂-alkyl-CO₂R¹⁷, wherein R¹⁷ is hydrogen or is absent (e.g., R¹² is —C₂-alkyl-CO₂⁻); R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂⁻); R⁴ is hydrogen; and R⁵ is hydrogen.

In some embodiments, the imidazoline is a compound of formula (II), wherein R¹ is unsubstituted C₂-C₆-alkyl; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂⁻); R^{x} is —CH₂CH₂CO₂R^{e}, wherein R^{e} is hydrogen (—H), C₁-C₆-alkyl, or R^{e} is absent (e.g., R^{x} is —CH₂CH₂CO₂⁻); R⁴ is hydrogen; and R⁵ is hydrogen.

In some embodiments, the imidazoline is a compound of formula (II), wherein R¹ is linear C₂-alkyl, substituted with one substituent that is a terminal —N(R¹²)(R¹³), wherein R¹² is hydrogen and R¹³ is —COR¹⁴, wherein R¹⁴ is —C₁₇H₃₅, —C₁₇H₃₃, or —C₁₇H₃₁; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂⁻); R^{x} is —CH₂CH₂CO₂R^{e}, wherein R^{e} is hydrogen (—H), C₁-C₆-alkyl, or R^{e} is absent (e.g., R^{x} is —CH₂CH₂CO₂⁻); R⁴ is hydrogen; and R⁵ is hydrogen.

In certain embodiments, the imidazoline can be a compound of formula (II), wherein R¹ is linear C₂-alkyl, substituted with one substituent that is a terminal N—(R¹²)(R¹³), wherein R¹² and R¹³ are each a —C₂-alkyl-CO₂R¹⁷, wherein R¹⁷ is hydrogen or is absent (e.g., R¹² is —C₂-alkyl-CO₂⁻); R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂⁻); R^{x} is —CH₂CH₂CO₂R^{e}, wherein R^{e} is hydrogen (—H), C₁-C₆-alkyl, or R^{e} is absent (e.g., R^{x} is —CH₂CH₂CO₂⁻); R⁴ is hydrogen; and R⁵ is hydrogen.

In some embodiments, the imidazoline can be a compound of formula (III), wherein R¹ is unsubstituted C₂-C₆-alkyl; R² is —C₁₇H₃₅, —C₁₇H₃₃, or —C₁₇H₃₁; R⁴ is hydrogen; and R⁵ is hydrogen.

In some embodiments, the imidazoline can be a compound of formula (III), wherein R¹ is linear C₂-alkyl, substituted with one substituent that is a terminal —N(R¹²)(R¹³), wherein R¹² is hydrogen and R¹³ is —COR¹⁴, wherein R¹⁴ is —C₁₇H₃₅, —C₁₇H₃₃, or —C₁₇H₃₁; R² is —C₁₇H₃₅, —C₁₇H₃₃, or —C₁₇H₃₁; R⁴ is hydrogen; and R⁵ is hydrogen.

In certain embodiments, the imidazoline can be a compound of formula (III), wherein R¹ is linear C₂-alkyl, substituted with one substituent that is a terminal —N(R¹²)(R¹³), wherein R¹² and R¹³ are each a —C₂-alkyl-CO₂R¹⁷, wherein R¹⁷ is hydrogen or is absent (e.g., R¹² is —C₂-alkyl-CO₂⁻); R² is —C₁₇H₃₅, —C₁₇H₃₃, or —C₁₇H₃₁; R⁴ is hydrogen; and R⁵ is hydrogen.

It is to be understood, whether explicitly set forth or not, that formula (I), formula (II), and formula (III) are each intended to encompass the tautomeric, racemic, enantiomeric, diastereomeric, zwitterionic, and salt forms of said formulas. The imidazolines can exist in a zwitterionic form where R³ and/or R^{x} is derived from an acrylic acid.

In accordance with the present disclosure, the corrosion inhibitor compound may be a quaternary amine. Suitable quaternary amines include, but are not limited to, alkyl, hydroxyalkyl, alkylaryl, arylalkyl or arylamine quaternary salts.

Suitable alkyl, hydroxyalkyl, alkylaryl arylalkyl or arylamine quaternary salts include those alkylaryl, arylalkyl and arylamine quaternary salts of the formula [N+R^{5a}R^{6a}R^{7a}R^{8a}][X⁻] wherein R^{5a}, R^{6a}, R^{7a}, and R^{8a} contain one to 18 carbon atoms, and X is Cl, Br or I. For the quaternary amine, R^{5a}, R^{6a}, R^{7a}, and R^{8a} can each independently be selected from the group consisting of alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I.

Suitable quaternary ammonium salts include, but are not limited to, tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, and trialkyl benzyl quaternary ammonium compounds, wherein the alkyl group can contain between about 1 and about 24 carbon atoms, about 10 and about 18 carbon atoms, or about 12 to about 16 carbon atoms, such as for example, C₁₂₋₁₆ benzyl dimethyl ammonium chloride. Suitable quaternary ammonium compounds (quats) include, but are not limited to, trialkyl, dialkyl, dialkoxy alkyl, monoalkoxy, benzyl, and imidazolinium quaternary ammonium compounds, salts thereof, the like, and combinations thereof. The quaternary ammonium salt can be an alkylamine benzyl quaternary ammonium salt, a benzyl triethanolamine quaternary ammonium salt, or a benzyl dimethylaminoethanolamine quaternary ammonium salt.

The quaternary amine can be a benzalkonium salt represented by the formula:

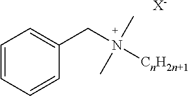

wherein n is 8, 10, 12, 14, 16, or 18; and X is Cl, Br or I.

The quaternary amine can be a mixture of benzalkonium salts wherein n is 8, 10, 12, 14, 16, and 18.

The quaternary amine can be a mixture of benzalkonium salts wherein n is 12, 14, 16, and 18.

The quaternary amine can be a mixture of benzalkonium salts wherein n is 12, 14, and 16.

The quaternary amine can be a mixture of benzalkonium salts wherein n is 12, 14, 16, and 18 and X is Cl.

The quaternary amine can be a mixture of benzalkonium salts wherein n is 12, 14, and 16, and X is Cl.

The quaternary amine can be an alkyl pyridinium quaternary salt such as those represented by the general formula:

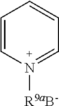

wherein R^{9a} is an alkyl group, an aryl group, or an arylalkyl group, wherein said alkyl groups have from 1 to about 18 carbon atoms and B is Cl, Br or I.

Among these compounds are alkyl pyridinium salts and alkyl pyridinium benzyl quats. Examples include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium and an alkyl benzyl pyridinium chloride. In some embodiments, the alkyl is a C₁-C₆ hydrocarbyl group.

The compositions disclosed herein include a phosphonium compound, such as a phosphonium salt. Suitable phosphonium salts include, but are not limited to, alkyltris(hydroxyorgano)phosphonium salts, alkenyltris(hydroxyorgano)phosphonium salts, and tetrakis(hydroxyorgano)phosphonium salts. The alkyltris(hydroxyorgano)phosphonium salts can be C₁-C₃-alkyltris(hydroxymethyl)phosphonium salts. The alkenyltris(hydroxyorgano)phosphonium salts can be C₂-C₃-alkenyltris(hydroxymethyl)phosphonium salts. The tetrakis(hydroxyorgano)phosphonium salts can be tetrakis(hydroxymethyl)phosphonium salts, including, but not limited to, tetrakis(hydroxymethyl)phosphonium sulphate (THPS), tetrakis(hydroxymethyl)phosphonium chloride, tetrakis(hydroxymethyl)phosphonium phosphate, tetrakis(hydroxymethyl)phosphonium formate, tetrakis(hydroxymethyl)phosphonium acetate, and tetrakis(hydroxymethyl)phosphonium oxalate. In some embodiments, the phosphonium salt is THPS.

The compound comprising multiple positive charges may be derived from a polyamine through its reactions with an activated olefin and an epoxide, wherein the activated olefin has the following formula:

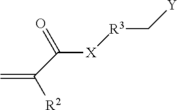

wherein X is NH or O; R² is H, CH₃, or an unsubstituted, linear or branched C₂-C₁₀ alkyl, alkenyl, or alkynyl group; R³ is absent or an unsubstituted, linear C₁-C₃₀ alkylene group; Y is —NR₄R₅R₆⁽⁺⁾; R⁴, R⁵, and R⁶ are independently a C₁-C₁₀ alkyl group; wherein the epoxide has the following formula;

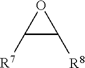

R⁷ is H or alkyl; and R⁸ is alkyl, or —(CH₂)ₖ—O-alkyl, wherein k is an integer of 1-30; wherein the polyamine and activated olefin undergo aza Michael Addition reaction and the polyamine and epoxide undergo ring opening reaction. In some embodiments, the compound comprises a nonionic group.

In some embodiments, the compound has one of the generic formula of NA₂-[R¹⁰]ₙ-NA₂, (RNA)ₙ-RNA₂, NA₂-(RNA)ₙ-RNA₂, or NA₂-(RN(R′))ₙ-RNA₂, wherein R¹⁰′ is a linear or branched, unsubstituted or substituted C₂-C₁₀ alkylene group, or combination thereof; R is —CH₂—, —CH₂CH₂—, —CH₂CH₂CH₂—, —CH(CH₃)CH₂—, a linear or branched, unsubstituted or substituted C₄-C₁₀ alkylene group, or combination thereof; R′ is —CH₂—, —CH₂CH₂—, —CH₂CH₂CH₂—, —CH(CH₃)CH₂—, a linear or branched, unsubstituted or substituted C₄-C₁₀ alkyl group, RNAB, RNARNAB, or RN(RNAB)₂; n can be from 2 to 1,000,000; A is a combination of H,

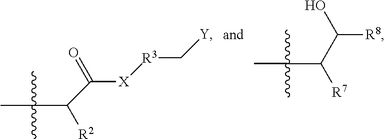

wherein X is NH or O; R² is H, CH₃, or an unsubstituted, linear or branched C₂-C₁₀ alkyl, alkenyl, or alkynyl group; R³ is absent or an unsubstituted, linear C₁-C₃₀ alkylene group; Y is -NR₄R₅R₆⁽⁺⁾; R⁴, R⁵, and R⁶ are independently a C₁-C₁₀ alkyl group; R⁷ is H or alkyl; and R⁸ is alkyl, or —(CH₂)ₖ—O-alkyl, wherein k is an integer of 1-30.

The compound may be a multiple charged cationic compound having a

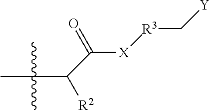

group and a

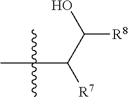

group.

In some aspects, the treatment chemical can be 2-mercaptoethanol, a diethylenetriamine (DETA): tall oil fatty acid (TOFA) imidazoline, a reaction product of trimethylamine (TEA) and TOFA, a reaction product of TOFA and tetraethylenepentamine (TEPA), an alkyl pyridine, an ethoxylated branched nonylphenol phosphate ester, a benzy-(C₁₂ to C₁₈ linear alkyl)-dimethylammonium chloride, 5-carboxy-4-hexyl-2-cyclohexene octanoic acid, 6-carboxy-4-hexyl-2-cyclohexene octanoic acid, maleated TOFA, an acrylated DETA:TOFA imidazoline, and any combination thereof.

In some embodiments, the treatment chemical is a corrosion inhibitor. The corrosion inhibitor may be selected from, for example, benzyl ammonium chloride, acrylated imidazoline, 2-mercaptoethanol, a quaternary ammonium compound, a phosphate ester, a substituted aromatic amine, an alkyl pyridine, a fatty acid amine condensate, and any combination thereof.

The presently disclosed corrosion inhibitor compositions are useful for inhibiting corrosion of metal surfaces in contact with any type of corrodent in the medium, such as a metal cation, a metal complex, a metal chelate, an organometallic complex, an aluminum ion, an ammonium ion, a barium ion, a chromium ion, a cobalt ion, a cuprous ion, a cupric ion, a calcium ion, a ferrous ion, a ferric ion, a hydrogen ion, a magnesium ion, a manganese ion, a molybdenum ion, a nickel ion, a potassium ion, a sodium ion, a strontium ion, a titanium ion, a uranium ion, a vanadium ion, a zinc ion, a bromide ion, a carbonate ion, a chlorate ion, a chloride ion, a chlorite ion, a dithionate ion, a fluoride ion, a hypochlorite ion, an iodide ion, a nitrate ion, a nitrite ion, an oxide ion, a perchlorate ion, a peroxide ion, a phosphate ion, a phosphite ion, a sulfate ion, a sulfide ion, a sulfite ion, a hydrogen carbonate ion, a hydrogen phosphate ion, a hydrogen phosphite ion, a hydrogen sulfate ion, a hydrogen sulfite ion, an acid, such as carbonic acid, hydrochloric acid, nitric acid, sulfuric acid, nitrous acid, sulfurous acid, a peroxy acid, or phosphoric acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sulfur dioxide, hydrogen peroxide, a polysaccharide, a metal oxide, sand, a clay, silicon dioxide, titanium dioxide, mud, an insoluble inorganic and/or organic particulate, an oxidizing agent, a chelating agent, an alcohol, and any combination of the foregoing.

The presently disclosed corrosion inhibitor compositions are useful for inhibiting corrosion of surfaces comprising any metal or combination of metals. In some aspects, the metal surface comprises steel, such as stainless steel or carbon steel. In some aspects, the metal surface comprises iron, aluminum, zinc, chromium, manganese, nickel, tungsten, molybdenum, titanium, vanadium, cobalt, niobium, copper, or any combination thereof. The metal surface may also comprise boron, phosphorus, sulfur, silicon, oxygen, nitrogen, and any combination thereof. In some aspects, a pipe, such as a pipeline, or any component in fluid communication with the pipe comprises the metal surface.

The corrosion inhibitor compositions disclosed herein also comprise an anti-emulsifier compound. The anti-emulsifier may comprise, for example, acrylic acid, a polymer comprising acrylic acid and T-butylphenol, such as CAS No. 178603-70-8, an oxyalkylate polymer, an ethylene oxide (EO) polymer, a propylene oxide (PO) polymer, formaldehyde, maleic anhydride, 4-nonylphenol, propenoic acid, a polymer comprising 2,5-furandione, methyloxirane and/or oxirane, a reaction product of EO-PO and an epoxy resin, such as CAS No. 68036-95-3, an acrylic acid polymer with T-butylphenol, formaldehyde, maleic anhydride, EO, PO, and 4-nonylphenol, such as CAS No. 129828-31-5, a propenoic acid polymer with 2,5-furandione, methyloxirane and oxirane, such as CAS No. 178603-71-9, and a reaction product of EO-PO, 4-nonylphenol, formaldehyde, maleic anhydride, and acrylic acid, such as CAS No. 67905-91-3.

Additional illustrative examples of anti-emulsifier compounds include dodecylbenzylsulfonic acid (DDBSA), the sodium salt of xylenesulfonic acid (NAXSA), an anionic surfactant, a cationic surfactant, a nonionic surfactant, a polyoxyalkylene, a vinyl polymer, a polyamine, a polyamide, a phenol, and a silicone polyether.

The compositions of the present disclosure may comprise various amounts of the compounds disclosed herein, such as the corrosion inhibitor compound and the anti-emulsifier compound.

For example, a composition may comprise from about 5 wt. % to about 90 wt. % of the corrosion inhibitor, such as from about 5 wt. % to about 80 wt. %, about 5 wt. % to about 70 wt. %, about 5 wt. % to about 60 wt. %, about 5 wt. % to about 50 wt. %, about 5 wt. % to about 40 wt. %, about 5 wt. % to about 30 wt. %, about 5 wt. % to about 20 wt. %, about 10 wt. % to about 20 wt. %, about 10 wt. % to about 30 wt. %, or about 10 wt. % to about 40 wt. % of the corrosion inhibitor.

Furthermore, a composition of the present disclosure may comprise from about 5 wt. % to about 90 wt. % of the anti-emulsifier, such as from about 5 wt. % to about 80 wt. %, about 5 wt. % to about 70 wt. %, about 5 wt. % to about 60 wt. %, about 5 wt. % to about 50 wt. %, about 5 wt. % to about 40 wt. %, about 5 wt. % to about 30 wt. %, about 5 wt. % to about 20 wt. %, about 10 wt. % to about 20 wt. %, about 10 wt. % to about 30 wt. %, or about 10 wt. % to about 40 wt. % of the anti-emulsifier.

In some embodiments, a composition may comprise from about 10 wt. % to about 30 wt. % of the corrosion inhibitor compound and from about 10 wt. % to about 30 wt. % of the anti-emulsifier compound. In some embodiments, the composition comprises a greater weight percentage of the anti-emulsifier compound than the corrosion inhibitor compound.

In certain embodiments, a composition comprises from about 10 wt. % to about 15 wt. % of the corrosion inhibitor compound and from about 10 wt. % to about 15 wt. % of the anti-emulsifier compound.

The compositions of the present disclosure may comprise the corrosion inhibitor compound and the anti-emulsifier compound in various weight ratios. For example, the composition may comprise a ratio of the anti-emulsifier compound to the corrosion inhibitor compound of about 20:1 to about 0.2:1, such as about 15:1, about 10:1, about 8:1, about 5:1, about 3:1, about 2.5:1, about 2:1, about 1.5:1, about 1:1, or about 0.5:1.

In some embodiments, a composition may comprise a ratio of anti-emulsifier to corrosion inhibitor of about 1:<10. In some embodiments, the weight ratio is about 1:0.1, about 1:0.5, about 1:0.75, about 1:0.9, about 1:0.95, or about 1:1. In some embodiments, the weight ratio of anti-emulsifier to corrosion inhibitor is from about 1:0.1 to about 1:5, from about 1:0.1 to about 1:4, from about 1:0.1 to about 1:3, from about 1:0.1 to about 1:2, from about 1:0.1 to about 1:1, from about 1:0.1 to about 1:0.95, from about 1:0.1 to about 1:0.9, from about 1:0.1 to about 1:0.75, or from about 1:0.1 to about 1:0.5.

In some embodiments, the ratio is from about 2.5:1 to about 0.5:1.

The compositions of the present disclosure may further comprise a solvent. Suitable solvents include, but are not limited to, an alcohol, a hydrocarbon, a ketone, an ether, an aromatic, an amide, a nitrile, a sulfoxide, an ester, a glycol ether, water, and combinations thereof. For example, the solvent can be water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or any combination thereof.

Representative polar solvents suitable for formulation with the composition include water, brine, seawater, an alcohol (including straight chain or branched aliphatic, such as methanol, ethanol, propanol, isopropanol, butanol, 2-ethylhexanol, hexanol, octanol, decanol, 2-butoxyethanol, etc.), a glycol and a glycol derivative (e.g., ethylene glycol, 1,2-propylene glycol, 1,3-propylene glycol, ethylene glycol monobutyl ether, etc.), a ketone (such as cyclohexanone, diisobutylketone), N-methylpyrrolidinone (NMP), N,N-dimethylformamide, and the like.

Representative non-polar solvents suitable for formulation with the composition include an aliphatic, such as pentane, hexane, cyclohexane, methylcyclohexane, heptane, decane, dodecane, diesel, and the like; and an aromatic, such as toluene, xylene, heavy aromatic naphtha, a fatty acid derivative (e.g., an acid, an ester, an amide), and the like.

In some embodiments, the solvent is methanol, isopropanol, 2-ethylhexanol, or a combination thereof. In certain embodiments, the solvent is methanol, isopropanol, 2-ethylhexanol, water, or a combination thereof.

A composition of the present disclosure may include from about 0 wt. % to about 99 wt. % of the solvent, such as from about 10 wt. % to about 80 wt. %, about 20 wt. % to about 80 wt. %, about 30 wt. % to about 70 wt. %, or about 40 wt. % to about 70 wt. % of the solvent.

A composition of the present disclosure may comprise about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, about 90 wt. %, or about 95 wt. % of the solvent.

In some embodiments, a composition comprises about 40 wt. % of an alcoholic solvent and about 15 wt. % of water. In some embodiments, a composition comprises about 40 wt. % of a methanol/isopropanol mixture and about 15 wt. % of water.

The present application discloses a novel and inventive approach where a high ratio of anti-emulsifier to corrosion inhibitor is formulated in a composition, which significantly enhances water separation from the oil phase. The improved fluid separation not only helps to overcome problems with emulsions but an unexpected benefit was discovered in the form of an increase in corrosion inhibitor active chemistry partitioning and corrosion inhibitor performance (even when the total amount of corrosion inhibitor remained the same). This, in turn, may allow for dose rate optimization and corrosion inhibitor reduction to further help reduce the emulsion tendency as well as reduce costs, chemical usage and handling with the associated safety, reduced carbon footprint, and sustainability benefits.

Any composition disclosed herein may comprise an additional treatment chemical. In some embodiments, the treatment chemical is selected from the group consisting of a hydrate inhibitor, an asphaltene inhibitor, a paraffin inhibitor, a biocide, a scale inhibitor, and any combination thereof.

A hydrate inhibitor may include, for example, a mono-alkyl amide, a dialkyl amide, an alkyl quaternary ammonium salt, and any combination thereof.

An asphaltene inhibitor may include, for example, an alkylphenol/formaldehyde resin, a polyisobutylene esters, a polyisobutylene imides, a polyalkyl acrylate, and any combination thereof.

A paraffin inhibitor may include, for example, a polyalkyl acrylate, an olefin/maleic anhydride polymer, and any combination thereof.

A biocide may include, for example, glutaraldehyde, tetrakis(hydroxymethyl)phosphonium sulphate, a quaternary ammonium compound, and any combination thereof.

A scale inhibitor may include, for example, a phosphonate, a sulfonate, a phosphate, a phosphate ester, a polymer comprising a phosphonate or phosphonate ester group, a polymeric organic acid, a peroxycarboxylic acid, and any combination thereof. In some embodiments, the scale inhibitor may be selected from a compound comprising an amine and/or a quaternary amine, nitrilotriacetic acid (NTA), ethylenediaminetetraacetic acid (EDTA), DETA phosphonate, and any combination thereof.

In some embodiments, the scale inhibitor is an acid-based scale inhibitor, such as phosphonic acid. In some embodiments, the scale inhibitor comprises an anionic group. The anionic group may comprise, for example, a carboxylate group or a sulfate group. In some embodiments, the scale inhibitor may include a phosphorous atom, a phosphorous-oxygen double bond, and/or a phosphono group.

In some embodiments, the scale inhibitor is selected from the group consisting of hexamethylene diamine tetrakis (methylene phosphonic acid), diethylene triamine tetra (methylene phosphonic acid), diethylene triamine penta (methylene phosphonic acid), polyacrylic acid (PAA), phosphino carboxylic acid (PPCA), diglycol amine phosphonate (DGA phosphonate), 1-hydroxyethylidene 1,1-diphosphonate (HEDP phosphonate), bisaminoethylether phosphonate (BAEE phosphonate), 2-acrylamido-2-methyl-1-propanesulphonic acid (AMPS), and any combination thereof.

In certain embodiments, the scale inhibitor is a polymer comprising an anionic monomer. The anionic monomer may be selected from, for example, acrylic acid, methacrylic acid, vinyl sulfonic acid, vinyl phosphonic acid, maleic anhydride, itaconic acid, crotonic acid, maleic acid, fumaric acid, styrene sulfonic acid, and any combination thereof.

In some embodiments, a composition disclosed herein may comprise an additional treatment chemical selected from a fouling control agent, a corrosion inhibitor intensifier, a biocide, a preservative, an acid, a hydrogen sulfide scavenger, a surfactant, an asphaltene inhibitor, a paraffin inhibitor, a scale inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an O₂ scavenger, a gelling agent, a lubricant, a friction reducing agent, a salt, a clay stabilizer, a bactericide, a salt substitute, a relative permeability modifier, a breaker, a fluid loss control additive, a chelating agent, an iron control agent, a drag reducing agent, a flow improver, a viscosity reducer, a solvent, and any combination thereof.

The fouling control agent may comprise, for example, a quaternary compound.

Illustrative, non-limiting examples of biocides include chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, tetrakis hydroxymethyl phosphonium sulphate, and any combination thereof.

The acid may comprise, for example, hydrochloric acid, hydrofluoric acid, citric acid, formic acid, acetic acid, or any combination thereof.

The hydrogen sulfide scavenger may comprise, for example, an oxidant, inorganic peroxide, chlorine dioxide, a C₁-C₁₀ aldehyde, formaldehyde, glyoxal, glutaraldehyde, acrolein, methacrolein, a triazine, or any combination thereof.

The composition may comprise, for example, from about 0 wt. % to about 90 wt. % of the additional treatment chemical. In some embodiments, the composition comprises from about 0.05 wt. % to about 80 wt. %, from about 0.05 wt. % to about 70 wt. %, from about 0.05 wt. % to about 60 wt. %, from about 0.05 wt. % to about 50 wt. %, from about 0.05 wt. % to about 40 wt. %, from about 0.05 wt. % to about 30 wt. %, from about 0.05 wt. % to about 20 wt. %, from about 0.05 wt. % to about 10 wt. %, from about 0.05 wt. % to about 1 wt. %, from about 1 wt. % to about 90 wt. %, from about 1 wt. % to about 75 wt. %, from about 1 wt. % to about 50 wt. %, from about 1 wt. % to about 25 wt. %, from about 1 wt. % to about 10 wt. %, from about 1 wt. % to about 5 wt. %, from about 10 wt. % to about 90 wt. %, from about 20 wt. % to about 90 wt. %, from about 30 wt. % to about 90 wt. %, from about 40 wt. % to about 90 wt. %, from about 50 wt. % to about 90 wt. %, from about 60 wt. % to about 90 wt. %, from about 70 wt. % to about 90 wt. %, or from about 80 wt. % to about 90 wt. % of the additional treatment chemical.

In some embodiments, the composition comprises, consists of, or consists essentially of a corrosion inhibitor compound and an anti-emulsifier compound. In some embodiments, the composition comprises, consists of, or consists essentially of a corrosion inhibitor compound, an anti-emulsifier compound, and an additional treatment chemical. In some embodiments, the composition comprises, consists of, or consists essentially of a corrosion inhibitor compound, a solvent, and an anti-emulsifier compound. In some embodiments, the composition comprises, consists of, or consists essentially of a corrosion inhibitor compound, a solvent, an anti-emulsifier compound, and an additional treatment chemical.

The compositions disclosed herein can be used in any industry where it is desirable to inhibit corrosion. For example, a composition can be applied to a gas or liquid produced or used in the production, transportation, storage, and/or separation of crude oil or natural gas. A fluid to which the composition can be introduced may be an aqueous medium. The aqueous medium can comprise water, gas, and optionally liquid hydrocarbon. A fluid to which the compositions can be introduced may be a liquid hydrocarbon. The liquid hydrocarbon may be any type of liquid hydrocarbon including, but not limited to, crude oil, heavy oil, processed residual oil, bitminous oil, coker oils, coker gas oils, fluid catalytic cracker feeds, gas oil, naphtha, fluid catalytic cracking slurry, diesel fuel, fuel oil, jet fuel, gasoline, and kerosene. The fluid or gas may also be a refined hydrocarbon product.

A fluid or gas treated with a composition of the disclosure can be at any selected temperature, such as ambient temperature or an elevated temperature. For example, the fluid (e.g., water, liquid hydrocarbon, etc.) or gas can be at a temperature of from about 40° C. to about 250° C. In some embodiments, the fluid or gas can be at a temperature of from about −50° C. to about 300° C., about 0° C. to about 200° C., about 10° C. to about 100° C., or about 20° C. to about 90° C.

The compositions disclosed herein can be added to a fluid at various levels of water cut. For example, the water cut can be from about 0% to about 100% volume/volume (v/v), from about 1% to about 80% v/v, or from about 1% to about 60% v/v. The fluid can be an aqueous medium that contains various levels of salinity. For example, the fluid can have a salinity of about 0% to about 25%, about 1% to about 24%, or about 10% to about 25% weight/weight (w/w) total dissolved solids (TDS).

The fluid or gas in which the compositions of the disclosure are introduced can be contained in and/or exposed to many different types of apparatuses. For example, the fluid or gas can be contained in an apparatus that transports fluid or gas from one point to another, such as an oil and/or gas pipeline. The apparatus can be part of an oil and/or gas refinery, such as a pipeline, a separation vessel, a dehydration unit, or a gas line. The fluid can also be contained in and/or exposed to an apparatus used in oil extraction and/or production, such as a wellhead.

The compositions disclosed herein may be introduced into a fluid or gas by any appropriate method for ensuring dispersal through the fluid or gas. The composition may be added at a point in a flow line upstream from the point at which corrosion prevention is desired. The composition may be injected using mechanical equipment, such as chemical injection pumps, piping tees, injection fittings, atomizers, quills, and the like. The compositions disclosed herein may be introduced with or without a solvent, such as a polar solvent or a non-polar solvent. The compositions may be pumped into an oil and/or gas pipeline using an umbilical line. Capillary injection systems may also be used to deliver the compositions to a selected fluid. In some embodiments, the compositions may be introduced into a liquid and mixed. The compositions may be injected into a gas stream as an aqueous or nonaqueous solution, mixture, or slurry. The fluid or gas may be passed through an absorption tower comprising a composition disclosed herein.

The present disclosure provides a method of inhibiting corrosion of a metal surface in an aqueous industrial system. In some embodiments, a subterranean formation and/or a pipeline comprises the metal surface. The method comprises adding a composition disclosed herein to a medium, such as an aqueous medium, of the aqueous industrial system.

In some embodiments, the method includes adding a composition disclosed herein to a subterranean reservoir. In certain embodiments, the composition is added to a medium in the subterranean formation. In some embodiments, the composition is added to a wellhead. In certain embodiments, the composition is added to a medium in the wellhead.

In some embodiments, a method of inhibiting corrosion includes adding a composition disclosed herein to a pipeline. In certain embodiments, the composition is added to a medium in the pipeline.

The present disclosure provides methods of inhibiting corrosion of a metal surface in contact with a medium. The methods comprise adding an effective amount of a composition to the medium, wherein the composition comprises, consists of, or consists essentially of a corrosion inhibitor compound and an anti-emulsifier compound. The composition may be added continuously, intermittently, automatically, and/or manually.

In accordance with the methods disclosed herein, the effective amount of the composition added to the system and/or the medium of the system is from about 1 ppm to about 10,000 ppm. For example, the effective amount may be from about 1 ppm to about 9,000 ppm, from about 1 ppm to about 8,000 ppm, from about 1 ppm to about 7,000 ppm, from about 1 ppm to about 6,000 ppm, from about 1 ppm to about 5,000 ppm, from about 1 ppm to about 4,000 ppm, from about 1 ppm to about 3,000 ppm, from about 1 ppm to about 2,000 ppm, from about 1 ppm to about 1,000 ppm, from about 1 ppm to about 500 ppm, from about 1 ppm to about 250 ppm, or from about 1 ppm to about 100 ppm. In some embodiments, the effective amount is from about 5 ppm to about 2,000 ppm.

The compositions and methods disclosed herein may be useful for carrying out various processes in an oil and gas operation but the compositions and methods may be used in processes from other industries, such as water treatment, geothermal, nuclear, etc.

### EXAMPLES

### Example 1

In a first series of experiments, a prior art corrosion inhibitor composition (CIA) was tested against a corrosion inhibitor composition in accordance with the present disclosure (CIB). CIA was a composition including about 37 wt. % of a quaternary ammonium compound and an imidazoline compound, about 3.25 wt. % of an oxyalkylate polymer anti-emulsifier (CAS No. 178603-70-8), and about 59.75 wt. % of a heavy aromatic naphtha solvent. The weight ratio of corrosion inhibitor to anti-emulsifier was greater than about 11:1. CIB was a composition including about 11.3 wt. % of the quaternary ammonium compound and the imidazoline compound used in CIA, about 11.9 wt. % of the oxyalkylate polymer anti-emulsifier (CAS No. 178603-70-8), and about 76.8 wt. % of a heavy aromatic naphtha solvent. The weight ratio of corrosion inhibitor to anti-emulsifier was 0.95:1.

Emulsion tendency tests were conducted using a brine (Brine A) containing about 1.65 g/L⁻¹, about 450 ppm acetic acid, and about 46° C. to about 48° C. API field oil (Oil A) at ambient temperature. Equal volumes (about 10 ml) of the brine and oil were transferred to a glass vessel to which an appropriate amount of the corrosion inhibitor composition was injected. The fluids were homogenized with an Ultra-Turrax (IKA T25 digital) at about 6,000 rpm for about 30 seconds and then the fluids were left to separate. The amount of water separated was assessed after about 10 minutes of settling after the mixing was stopped. Results can be seen in Table 1.

TABLE 1

| | | | | Approximate | Water |
|---|---|---|---|---|---|
| | | | | CI Active: | Separated |
| | Approximate | | Approximate | Anti- | After |
| CI | CI Activity | Dose Rate | CI Active | emulsifier | 10 minutes |
| Blend | (%) | (ppm) | Dose (ppm) | Ratio | (ml) |
| Blank | N/A | N/A | N/A | N/A | 10 |
| CIA | ~37 | 2,000 | ~740 | ~>11 | 2 |
| CIB | ~11.3 | 6,580 | ~740 | ~0.95 | 10 |

Table 2 shows additional testing results using the same components as CIA and CIB but different ratios of compounds as well as different anti-emulsifier chemistries.

TABLE 2

| | | | | | Water |
|---|---|---|---|---|---|
| | Anti- | Anti- | Approximate CI | | Separated |
| CI | emulsifier | emulsifier | Active: Anti- | Dose Rate | after 10 |
| Blend# | Chemistry | CAS# | emulsifier Ratio | (ppm) | min (ml) |
| Blank | N/A | N/A | N/A | N/A | 10 |
| 1 | Acrylic acid | 178603-70-8 | 0 | 2,000 | 2 |
| | polymer | | | | |
| | with T- | | | | |
| | buty(phenol | | | | |
| 2 | Acrylic acid | 178603-70-8 | 28.6 | 2,000 | 2 |
| | polymer | | | | |
| | with T- | | | | |
| | butylphenol | | | | |
| 3 | Acrylic acid | 178603-70-8 | 11.4 | 2,000 | 2 |
| | polymer | | | | |
| | with T- | | | | |
| | butylphenol | | | | |
| 4 | Acrylic acid | 178603-70-8 | 5.7 | 2,000 | 3 |
| | polymer with | | | | |
| | T- | | | | |
| | buty]phenol | | | | |
| 5 | Acrylic acid | 178603-70-8 | 2.9 | 2,000 | 5 |
| | polymer with | | | | |
| | T-butylphenol | | | | |
| 6 | Acrylic acid | 178603-70-8 | 1.4 | 2,000 | 10 |
| | polymer with | | | | |
| | T- | | | | |
| | butylphenol | | | | |
| 7 | Reaction | 68036-95-3 | 1.2 | 2,000 | 10 |
| | Product of EO- | | | | |
| | PO and EPON | | | | |
| 8 | Acrylic acid | 129828-31-5 | 1.8 | 2,000 | 10 |
| | polymer with | | | | |
| | T- butylphenol, | | | | |
| | fonnaldehyde, | | | | |
| | maleic | | | | |
| | anhydride, EO, | | | | |
| | PO, & 4- | | | | |
| | nonylphenol | | | | |
| 9 | Propenoic acid | 178603-71-9 | 1.5 | 2,000 | 10 |
| | polymer with | | | | |
| | 2,5-furandione, | | | | |
| | methyloxirane | | | | |
| | and oxirane | | | | |
| 10 | Reaction | 67905-91-3 | 1.4 | 2,000 | 10 |
| | Product of EO- | | | | |
| | PO, 4- | | | | |
| | Nonylphenol, | | | | |
| | HCHO, maleic | | | | |
| | anhydride, and | | | | |
| | acrylic acid | | | | |

To assess the partitioning of CIA and CIB containing the same active corrosion inhibitor chemistry but different corrosion inhibitor:anti-emulsifier ratio, partitioning assessments were carried out using Brine A and Oil A at a water cut of about 10% (10:90 brine:oil) at both 85° C. and 25° C.

In the partitioning assessment, CIA and CIB were injected on total fluids to dose the same amount of corrosion inhibitor actives in each case to take into account the differences in overall activity. After corrosion inhibitor injection into the brine and oil mixture, the fluids were vigorously mixed using an Ultra-Turax (HCA T25 digital) at about 6,000 rpm for 30 seconds and then left to settle. After separation, an aliquot of the brine phase was taken and the corrosion inhibitor concentration was determined in the water by the methyl orange assessment.

Commercially available CHEMets filming amine kits from CHEMetrics were used to determine the residual value of the corrosion inhibitor components via the methyl orange method. The filming component within the corrosion inhibitor reacts with methyl orange to form a yellow complex. The corrosion inhibitor residual is then quantified photometrically using a visible spectrophotometer. The intensity of the color was directly related to the concentration of the filming component, and hence, the concentration of the corrosion inhibitor.

As can be seen from Table 3, an enhancement in the corrosion inhibitor active partitioning by about 25% in CIB (47-48% partitioning) compared with CIA (37-38% partitioning) is gained. This is explained by the anti-emulsifier package reformulation reducing the corrosion inhibitor actives negatively impacted by the emulsion as well as improving mass transport from the oil to the water phase.

TABLE 3

| | | | | Corrosion | | |
|---|---|---|---|---|---|---|
| | | | Corrosion | Inhibitor | Theoretical | |
| | | | Inhibitor | Product | CI Product | |
| | | | Product | Residual | Residual | |
| Corrosion | Approximate | | Dose Based | in Aqueous | Assuming | |
| Inhibitor | CI Active:Anti- | | on Total | Phase from | 100% | CI |
| Product | emulsifier | Temperature | Fluids | Methyl Orange | Partitioning | Partitioning |
| Blend | Ratio | (° C.) | (ppm) | (ppm) | (ppm) | (%) |
| CIA | ~>11 | 25 | 100 | 372 | 1,000 | 37 |
| CIA | ~>11 | 85 | 100 | 381 | 1,000 | 38 |
| CIB | ~0.95 | 25 | 333 | 1,577 | 3,330 | 47 |
| CIB | ~0.95 | 85 | 333 | 1,590 | 3,330 | 48 |

Corrosion bubble cell tests were performed using the following conditions to evaluate the corrosion inhibition performance of the corrosion inhibitor compositions on a carbon steel electrode (C1018 grade). The corrosion rate was assessed electrochemically using linear polarization resistance (LPR) methodology. Tests were carried out at atmospheric pressure at about 80° C. using CO₂ saturated fluids with about 3% NaCl brine (about 80%) and LVT-200 hydrocarbon (about 20%) with a continuous CO₂ sparge.

About 3 to 4 hours pre-corrosion time (i.e., with no corrosion inhibitor) was carried out before the corrosion inhibitor was injected. The inhibited corrosion rate at about 15 hours after corrosion inhibitor injection was noted and a percentage inhibition was determined by comparing with the corrosion rate of immediately before corrosion inhibitor injection to that about 15 hours after corrosion inhibitor injection. The results are shown in Table 4.

TABLE 4

| | | | Approximate | Corrosion | | |
|---|---|---|---|---|---|---|
| | | Dose Rate | CI Active | Rate After | Corrosion | |
| | Approximate | (based on | Chemistry | Pre-Corrosion | Rate After | |
| | CI Active | water | Dose (based | Before CI | 15 h of CI | |
| CI | Chemistry | phase] | on water | Injection | Injection | % |
| Blend | (%) | (ppm) | Phase) -ppm | (mpy) | (mpy) | Protection |
| Blank | NIA | NIA | NIA | 228 | 441 | −93 |
| CIA | 37 | 50 | 19 | 214 | 13 | 94.2 |
| CIA | 37 | 100 | 37 | 216 | 8 | 96.2 |
| CIA | 37 | 200 | 74 | 243 | 8 | 96.7 |
| CIB | 11.3 | 133 | 15 | 305 | 9 | 97.1 |
| CIB | 11.3 | 333 | 38 | 223 | 6 | 97.2 |
| CIB | 11.3 | 667 | 75 | 204 | 2 | 99.1 |

As can be seen, enhanced corrosion inhibitor performance was gained when approximately the same amount of active chemistry was dosed using a lower corrosion inhibitor:anti-emulsifier ratio in CIB (approximate corrosion inhibitor:anti-emulsifier ratio of ˜0.95) compared with CIA (approximate corrosion inhibitor:anti-emulsifier ratio of ˜>11).

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a corrosion inhibitor” is intended to include “at least one corrosion inhibitor” or “one or more corrosion inhibitors.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A composition, comprising:
a corrosion inhibitor, and
an anti-emulsifier, wherein the composition comprises a weight ratio of the anti-emulsifier to the corrosion inhibitor of about 20:1 to about 0.2:1.

2. The composition of claim 1, wherein the weight ratio is about 2.5:1 to about 0.5:1.

3. The composition of claim 1, wherein the composition comprises a greater amount of the anti-emulsifier than the corrosion inhibitor.

4. The composition of claim 1, wherein the corrosion inhibitor comprises a quaternary amine compound and/or an imidazoline compound.

5. The composition of claim 4, wherein the imidazoline compound comprises formula (I), (II), or (III): 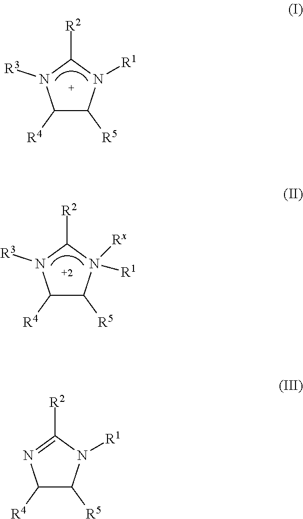
wherein R¹, R⁴, and R⁵ are each independently selected from hydrogen, alkyl, alkenyl, alkynyl, cycloalkyl, cycloalkenyl, aryl, heteroaryl, and heterocycle, said alkyl, alkenyl, alkynyl, cycloalkyl, cycloalkenyl, aryl, heteroaryl, and heterocycle each independently, at each occurrence, unsubstituted or substituted with 1 to 3 substituents independently selected from halogen, —COR⁶, —CO₂R⁷, —SO₃R⁸, —PO₃H₂, —CON(R⁹)(R¹⁰), —OR¹¹, and —N(R¹²)(R¹³);
R² is a radical derived from a fatty acid;
R³ and R^{x} are each independently selected from a radical derived from an unsaturated acid;
R⁶, R⁷, R⁸, R⁹, R¹⁰, and R¹¹ are each independently, at each occurrence, selected from hydrogen, alkyl, and alkenyl;
R¹² and R¹³ are each independently, at each occurrence, selected from hydrogen, alkyl, —COR¹⁴, —CO₂R¹⁵, -alkyl-COR¹⁶, and -alkyl-CO₂R¹⁷; and
R¹⁴, R¹⁵, R¹⁶, and R¹⁷ are each independently, at each occurrence, selected from hydrogen, alkyl, and alkenyl.

6. The composition of claim 4, wherein the quaternary amine compound is an alkyl quaternary salt, a hydroxyalkyl quaternary salt, an alkylaryl quaternary salt, an arylalkyl quaternary salt or an arylamine quaternary salt.

7. The composition of claim 1, wherein the anti-emulsifier is selected from the group consisting of dodecylbenzylsulfonic acid (DDBSA), a salt of xylenesulfonic acid (NAXSA), an epoxylated compound, a propoxylated compound, an anionic surfactant, a cationic surfactant, a nonionic surfactant, a resin, a vinyl polymer, a polyamine, a polyamide, a phenol, a silicone polyether, and any combination thereof.

8. The composition of claim 1, wherein the anti-emulsifier comprises an oxyalkylate polymer or acrylic acid and t-butyl phenol.

9. The composition of claim 1, wherein the composition is an aqueous composition.

10. The composition of claim 1, further comprising a solvent selected from the group consisting of an alcohol, a hydrocarbon, a ketone, an ether, an aromatic, an amide, a nitrile, a sulfoxide, an ester, a glycol ether, and any combination thereof.

11. The composition of claim 1, wherein the composition comprises from about 10 wt. % to about 15 wt. % of the corrosion inhibitor and about 10 wt. % to about 15 wt. % of the anti-emulsifier.

12. The composition of claim 1, wherein the composition excludes a phosphonium compound.

13. The composition of claim 1, wherein the corrosion inhibitor excludes a compound comprising multiple charges.

14. A method of inhibiting corrosion of a metal surface, comprising: adding a composition to an aqueous system comprising the metal surface, wherein the composition comprises a corrosion inhibitor, and an anti-emulsifier, further wherein the composition comprises a weight ratio of the anti-emulsifier to the corrosion inhibitor of about 20:1 to about 0.2:1.

15. The method of claim 14, wherein from about 25 ppm to about 10,000 ppm of the composition is added to the aqueous system.

16. The method of claim 14, wherein from about 10 ppm to about 2,000 ppm of the corrosion inhibitor is added to the aqueous system.

17. The method of claim 14, wherein the weight ratio is from about 2.5:1 to about 0.5:1.

18. The method of claim 14, wherein the corrosion inhibitor comprises a quaternary amine compound and/or an imidazoline compound.

19. The method of claim 14, wherein the anti-emulsifier is selected from the group consisting of dodecylbenzylsulfonic acid (DDBSA), a salt of xylenesulfonic acid (NAXSA), an epoxylated compound, a propoxylated compound, an anionic surfactant, a cationic surfactant, a nonionic surfactant, a resin, a vinyl polymer, a polyamine, a polyamide, a phenol, a silicone polyether, and any combination thereof.

20. The method of claim 14, wherein the anti-emulsifier comprises an oxyalkylate polymer.
